(19) United States
(12) Patent Application Publication
(10) Pub. No.: US 2018/0024610 A1
(43) Pub. Date: Jan. 25, 2018

(54) APPARATUS AND METHOD FOR SETTING A CLOCK SPEED/VOLTAGE OF CACHE MEMORY BASED ON MEMORY REQUEST INFORMATION

(71) Applicant: Futurewei Technologies, Inc., Plano, TX (US)

(72) Inventor: Chukwuchebem Orakwue, San Diego, CA (US)

(21) Appl. No.: 15/217,911

(22) Filed: Jul. 22, 2016

(51) Int. Cl. G06F 1/32; G06F 12/0891; G06F 12/0862; G06F 12/0815

(52) U.S. Cl. CPC G06F 1/324; G06F 12/0815; G06F 12/0891; G06F 12/0862; G06F 1/3296; G06F 2212/621; G06F 2212/602

(57) ABSTRACT

An apparatus and method are provided for setting a clock speed/voltage of cache memory based on memory request information. In response to receiving a memory request, information is identified in connection with the memory request, utilizing hardware that is in electrical communication with cache memory. Based on the information, a clock speed and/or a voltage of at least a portion of the cache memory is set, utilizing the hardware that is in electrical communication with the cache memory.

### FIELD OF THE INVENTION

The present invention relates to cache memory, and more particularly to setting a clock speed and/or voltage for cache memory.

### BACKGROUND

Modern processors typically use cache memory to store data in a manner that allows for faster access to such data, thereby improving overall performance. Such cache memory is typically equipped with a dynamic voltage/frequency scaling (DVFS) capability for altering the voltage and/or clock frequency with which the cache memory operates, for power conservation purposes. To date, such DVFS capability is often limited to systems that scale the voltage/frequency in an idle mode (e.g. when memory requests are not being serviced, etc.), or simply scale the voltage/frequency strictly based on a clock of the processor, agent, etc. that is being serviced.

### SUMMARY

A method is provided for setting a clock speed/voltage of cache memory based on memory request information. In response to receiving a memory request, information is identified in connection with the memory request, utilizing hardware that is in electrical communication with cache memory. Based on the information, a clock speed and/or a voltage of at least a portion of the cache memory is set, utilizing the hardware that is in electrical communication with the cache memory.

Also provided is an apparatus and system for setting a clock speed/voltage of cache memory based on memory request information. Circuitry is included that is configured to identify information in connection with a memory request, in response to receiving the memory request. Based on the information, additional circuitry is configured to set a clock speed and/or a voltage of at least a portion of the cache memory.

In a first embodiment, the information may be related to at least a portion of at least one processor that caused the memory request. For example, the information may be related to a clock speed and/or a voltage of the portion of the processor that caused the memory request.

In a second embodiment (which may or may not be combined with the first embodiment), the information may be related to a type of the memory request (e.g. a read type, a coherence type, a write type, a prefetch type, or a flush type, etc.).

In a third embodiment (which may or may not be combined with the first and/or second embodiments), the information may be related to a status of data that is a subject of the memory request (e.g. a hit status, a miss status, or a hit-on-prior-miss status, etc.).

In a fourth embodiment (which may or may not be combined with the first, second, and/or third embodiments), the information may be related to an action of the cache memory that is caused by the memory request (e.g. a read action, a write action, a request to external memory, a flush action, or a null action, etc.).

In a fifth embodiment (which may or may not be combined with the first, second, third, and/or fourth embodiments), the information may be identified from a field of the memory request (e.g. a requestor identification field, a type field, etc.).

In a sixth embodiment (which may or may not be combined with the first, second, third, fourth, and/or fifth embodiments), the at least one of the clock speed or the voltage may be set to at least one of a clock speed or a voltage of at least a portion of at least one processor that exhibits a highest clock speed or voltage.

In a seventh embodiment (which may or may not be combined with the first, second, third, fourth, fifth, and/or sixth embodiments), at least one of the clock speed or the voltage may be set for a subset of the cache memory.

In an eighth embodiment (which may or may not be combined with the first, second, third, fourth, fifth, sixth, and/or seventh embodiments), at least one of the clock speed or the voltage may be set for an entirety of the cache memory.

In a ninth embodiment (which may or may not be combined with the first, second, third, fourth, fifth, sixth, seventh, and/or eighth embodiments), both the clock speed and the voltage may be set, based on the information.

In a tenth embodiment (which may or may not be combined with the first, second, third, fourth, fifth, sixth, seventh, eighth, and/or ninth embodiments), the hardware may be integrated with the cache memory.

In an eleventh embodiment (which may or may not be combined with the first, second, third, fourth, fifth, sixth, seventh, eighth, ninth, and/or tenth embodiments), the information may be identified from a field of the memory request in the form of a requestor identification field and/or a type field.

To this end, in some optional embodiments, one or more of the foregoing features of the aforementioned apparatus, system and/or method may enable clock speed and/or voltage control while the cache memory is active, where such control may be administered with greater precision as a result of the particular information that is identified in connection with active memory requests. This may, in turn, result in greater power savings that would otherwise be foregone in systems that lack such fine-grained clock speed and/or voltage control. In other embodiments, performance may also be enhanced, as well. It should be noted that the aforementioned potential advantages are set forth for illustrative purposes only and should not be construed as limiting in any manner.

### BRIEF DESCRIPTION OF THE DRAWINGS

FIG. 1 illustrates a method for setting a clock speed/voltage of cache memory based on memory request information, in accordance with one embodiment.

FIG. 2 illustrates a system for setting a clock speed/voltage of cache memory based on memory request information, in accordance with another embodiment.

FIG. 3 illustrates a shared cache controller for setting a clock speed/voltage of cache memory based on memory request information, in accordance with yet another embodiment.

FIG. 4 illustrates a sample memory request with information that may be used for setting a clock speed/voltage of cache memory, in accordance with yet another embodiment.

FIG. 5 illustrates a method for setting a clock speed/voltage of cache memory based on memory request information, in accordance with yet another embodiment.

FIG. 6 illustrates additional variations for setting a clock speed/voltage of cache memory based on memory request information, in accordance with yet another embodiment.

FIG. 7A illustrates an exemplary timing diagram for setting a clock speed/voltage of cache memory based on memory request information, in accordance with yet another embodiment.

FIG. 7B illustrates a system for setting a clock speed/voltage of cache memory based on memory request information, in accordance with one embodiment.

FIG. 8 illustrates a network architecture, in accordance with one possible embodiment.

FIG. 9 illustrates an exemplary system, in accordance with one embodiment.

### DETAILED DESCRIPTION

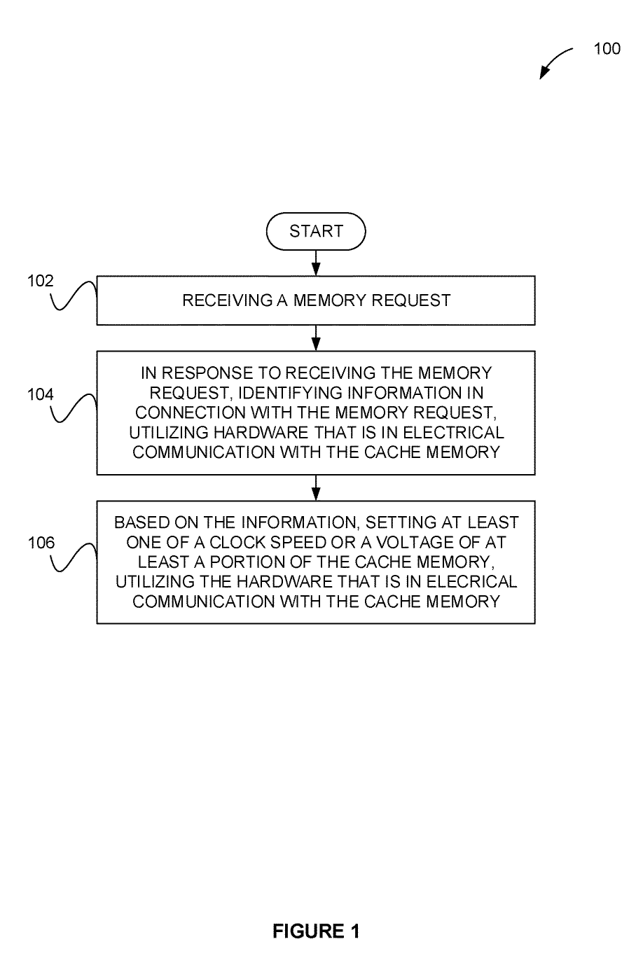

FIG. 1 illustrates a method 100 for setting a clock speed/voltage of cache memory based on memory request information, in accordance with one embodiment. As shown, a memory request is received in step 102. In the context of the present description, such memory request may include any request that is intended to cause an action in cache memory.

As indicated in step 104, information is identified in connection with the memory request, in response to receiving the memory request. In the present description, such information may include any information that is included in the memory request or any information derived from and/or caused to be created by content of the memory request. As shown in FIG. 1, step 104 is carried out utilizing hardware that is in electrical communication with cache memory. Such hardware may include any hardware (e.g. integrated, discrete components, etc.) that is capable of identifying the information and using the same. Further, the term “electrical communication,” in the context of the present description, may refer to any direct and/or indirect electrical coupling between relevant electric components. For instance, such electric components may be in electrical communication with or without intermediate components therebetween.

Also in the context of the present description, the cache memory may include any random access memory (RAM) that is capable of being accessed more quickly than other RAM in a system. For example, in one possible embodiment, the cache memory may include static random access memory (SRAM) or any other type of RAM. Embodiments are also contemplated where the cache memory includes a hybrid memory-type/class system.

In one embodiment, the cache memory may include shared cache memory that is separate from local cache memory. In such embodiment, separate instances of the local cache memory may be accessed by only one of a plurality of separate computer or processor components (e.g. clusters, cores, snooping agents, etc.), while the shared cache memory may be shared among multiple of the separate computer or processor components. It should be noted that the aforementioned processor(s) may include a general purpose processor, central processing unit, graphics processor, and/or any other type of desired processor.

In one embodiment, the information may be related to at least a portion of at least one processor that caused the memory request. For example, the information may be related to a clock speed and/or a voltage of at least a portion of at least one processor that caused the memory request. In another embodiment, the information may be related to a type of the memory request (e.g. a read type, a write type, a coherence type, a prefetch type, or a flush type, etc.). In the context of the present description, a read type memory request may involve a request to read data from memory, a write type memory request may involve a request to write data to memory, a coherence type memory request may involve a request that ensures that data is consistent among multiple storage places in a system, a prefetch type memory request may involve a request that attempts to make data available to avoid a miss, and a flush type memory request may involve a request that empties at least a portion of the cache memory.

In yet another embodiment, the information may be related to a status of data that is a subject of the memory request (e.g. a hit status, a miss status, or a hit-on-prior-miss status, etc.). In the context of the present description, a hit status may refer to a situation where a memory request for data results in the data being available for access in the cache memory, a miss status may refer to a situation where a memory request for data does not result in the data being available for access in the cache memory, a hit-on-prior-miss status may refer to a situation where a memory request for data results in the data being available for access in the cache memory after a previous memory request for the same data did not result in the data being available for access in the cache memory.

In still yet another embodiment, the information may be related to an action of the cache memory that is caused by the memory request (e.g. a read action, a write action, a request to external memory, a flush action, or a null action, etc.). In the context of the present description, the read action may refer to any action that results in data being read from the cache memory, the write action may refer to any action that results in data being written to the cache memory, the request to external memory may refer to any action where data is requested from a memory other than the cache memory, the flush action may refer to any action that results in at least some data being emptied from the cache memory, and the null action may refer to any situation where no action is taken in response to a memory request.

While the foregoing information may be identified in any desired manner, the information may, in one embodiment, be identified from a field of the memory request (e.g. a requestor identification field, a type field, etc.). More details regarding the foregoing information will be set forth hereinafter in greater detail during the description of subsequent embodiments.

Based on the information identified in step 104, a clock speed and/or a voltage of at least a portion of the cache memory is set in operation 106, utilizing the hardware that is in electrical communication with the cache memory. It should be noted that the one or more portions of the hardware that is utilized in connection with steps 104 and 106 may or may not be the same. Further, the hardware may or may not be integrated with the cache memory (or any other component including, but not limited to a processor, memory controller, etc.).

In one embodiment, both the clock speed and the voltage may be set, while, in other embodiments, only the clock speed or only the voltage may be set. For example, in one embodiment, the clock speed and the voltage may include an operating point (OPP) of the cache memory. Further, the clock speed and/or the voltage may be set for a subset of the cache memory, or an entirety of the cache memory. In the case of the former, the subset of the cache memory may include at least one bank of the cache memory, or any subset thereof, for that matter.

More illustrative information will now be set forth regarding various optional architectures and uses in which the foregoing method may or may not be implemented, per the desires of the user. It should be noted that the following information is set forth for illustrative purposes and should not be construed as limiting in any manner. Any of the following features may be optionally incorporated with or without the exclusion of other features described.

For example, in some optional embodiments, the method 100 may enable clock speed and/or voltage control while the cache memory is active. Such control may be administered with greater precision as a result of the information that is identified in connection with active memory requests. This may, in turn, result in greater power savings that would otherwise be foregone in systems that lack such fine-grained clock speed and/or voltage control. In other embodiments, performance may also be enhanced, as well. Just by way of example, in one possible embodiment, cache memory that is the subject of a high rate of snooping (to achieve cache coherence, etc.), may avoid stalls by virtue of clock speed and/or voltage control being set commensurate with the snooping device. Of course, the foregoing potential advantages are strictly optional.

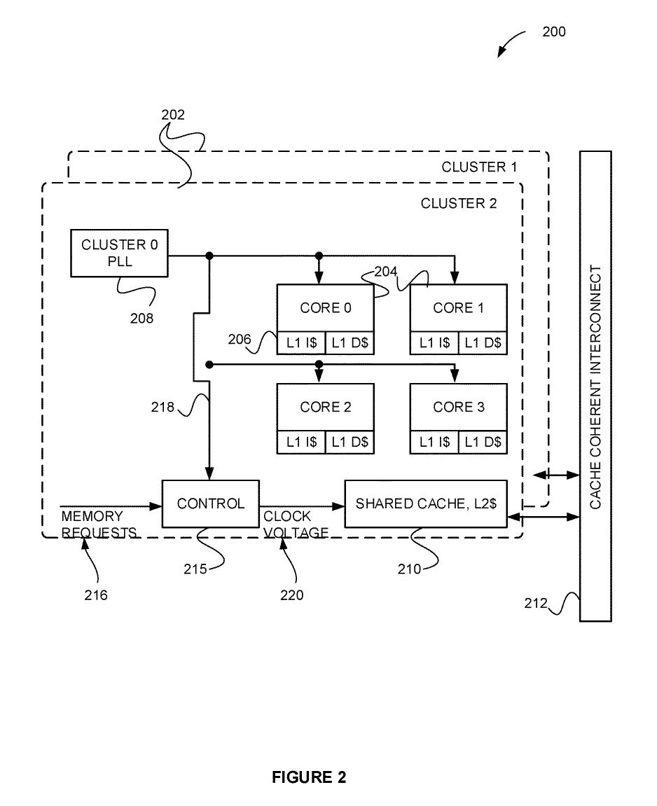

FIG. 2 illustrates a system 200 for setting a clock speed/voltage of cache memory based on memory request information, in accordance with another embodiment. As an option, the system 200 may be implemented in the context of any one or more of the embodiments set forth in any previous and/or subsequent figure(s) and/or description thereof. However, it is to be appreciated that the system 200 may be implemented in the context of any desired environment.

As shown, the system 200 includes a plurality of clusters 202 that each include a plurality of cores 204. In use, each of the cores 204 may be independently and/or collectively assigned computing tasks which, in turn, may have various computing and storage requirements. At least a portion of such storage requirements may be serviced by local cache memory 206 that is integrated with the plurality of cores 204. Further, the cores 204 may be driven by a cluster clock 208 [e.g. phase locked loop (PLL) circuit, etc.], in the manner shown.

Further provided is a shared cache memory 210 that is in electrical communication with the cores 204 of the clusters 202 via a cache coherent interconnect 212. By this design, the shared cache memory 210 is available to the cores 204 in a manner similar to that in which the local cache memory 206 is available. Further, the cache coherent interconnect 212 may further be utilized to ensure that, to the extent that common data is stored in both the local cache memory 206 and the shared cache memory 210, such common data remains consistent.

With continuing reference to FIG. 2, a shared cache controller 215 is provided that is in electrical communication with the shared cache memory 210. As further shown, the shared cache controller 215 receives, as input, memory requests 216 that are prompted by the cores 204 of the clusters 202 (and/or other sources) and may be received via any desired route (e.g. via a memory controller (not shown), directly from the cores 204, via other componentry, etc.). As further input, the shared cache controller 215 further receives one or more clock signals 218 in connection with the cores 204 and/or any other system components that are serviced by the shared cache controller 215.

In operation, the shared cache controller 215 utilizes the memory requests 216 and/or one or more clock signals 218 (and/or any information gleaned therefrom) to output at least one clock and/or voltage signal 220 to the shared cache memory 210 for the purpose of setting the clock and/or voltage at which the shared cache memory 210 operates. To this end, the shared cache memory 210 may be operated with enhanced power savings by setting the clock and/or voltage as a function of the memory requests 216 and possibly the clock signals 218. In various embodiments, the level of such enhanced power savings may depend on what information is gleaned and how it is used for setting the clock and/or voltage of the shared cache memory 210. More information will now be set forth regarding one possible architecture for the shared cache controller 215.

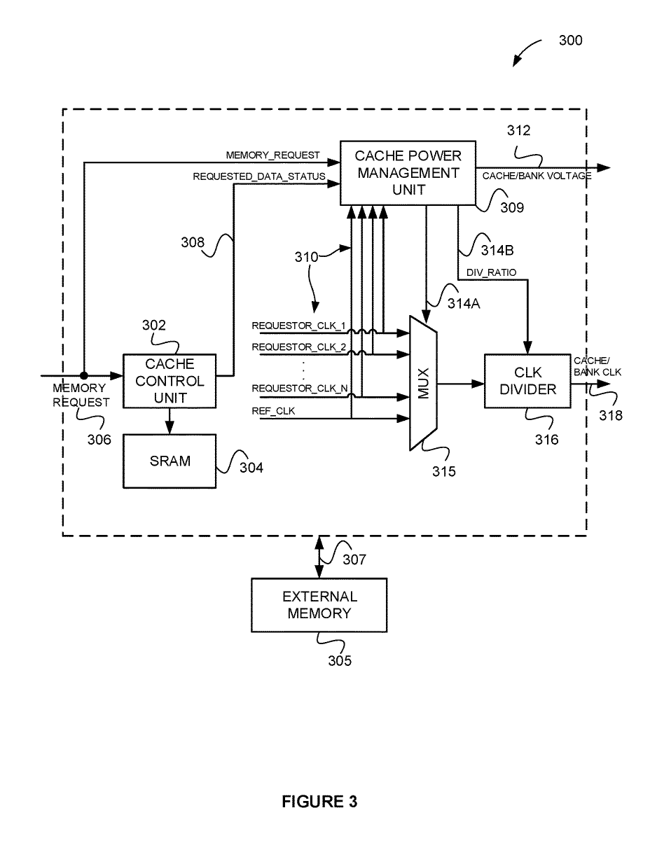

FIG. 3 illustrates a shared cache controller 300 for setting a clock speed/voltage of cache memory based on memory request information, in accordance with yet another embodiment. As an option, the shared cache controller 300 may be implemented in the context of any one or more of the embodiments set forth in any previous and/or subsequent figure(s) and/or description thereof. For example, in one embodiment, the shared cache controller 300 may include the shared cache controller 215 of FIG. 2. However, it is to be appreciated that the shared cache controller 300 may be implemented in the context of any desired environment.

As illustrated, the shared cache controller 300 includes a cache control unit 302 that remains in electrical communication with SRAM 304 that operates as a cache. In use, the cache control unit 302 receives a plurality of memory requests 306 that may take on any one or more of a variety of types (e.g. a read type, a write type, a coherence type, a prefetch type, or a flush type, etc.). As will become apparent hereinafter during the description of subsequent embodiments, the memory requests 306 may include a variety of fields including a data field with data to be operated upon, a type field identifying the memory request type, etc. In response to the memory requests 306, the cache control unit 302 causes one or more actions (e.g. a read action, a write action, a request to external memory, a flush action, or a null action, etc.) in connection with the SRAM 304.

As further shown, the memory requests 306 may also prompt the shared cache controller 300 to interact with (e.g. read from, write to, etc.) external memory 305 via one or more buses 307. Even still yet, the cache control unit 302 may further report data status signals 308 (e.g. a hit, a miss, or a hit-on-prior-miss, etc.) that resulted from each memory request 306. In one embodiment, such data status signals 308 may be pushed without necessarily being requested while, in other embodiments, the data status signals 308 may be requested by other components of the shared cache controller 300.

The shared cache controller 300 further includes a cache power management unit 309 that receives, as input, the memory requests 306, the data status signals 308, and a plurality of clock signals 310. Such clock signals 310 may include a clock signal for each of a plurality of components (e.g. computers, processors, cores, snoop agents, portions thereof, etc.) that are to be serviced by the SRAM 304 (e.g. REQUESTOR_CLK1, REQUESTOR_CLK2 . . . REQUESTOR_CLKN, etc.). Further, a reference clock (REF_CLK) may be provided, as well.

In operation, the shared cache controller 300 serves to output voltage settings 312 for setting an operating voltage for the SRAM 304 (and/or any portion thereof), as well as internal clock settings 314A, 314B for setting an operating clock frequency for the SRAM 304 (and/or any portion thereof). Further, such voltage settings 312 and internal clock settings 314A, 314B are specifically set as a function of information gleaned, derived, and/or arising (through causation) from contents of the memory requests 306 including, but not limited to fields of the memory requests 306, the data status signals 308, and/or any other information that is collected and/or processed in connection with the memory requests 306.

As shown, in order to set the clock of the SRAM 304, the internal clock settings 314A, 314B include a clock select signal 314A that is fed to a multiplexer 315 that feeds one of clock signals 310 to a clock divider 316 which divides the clock signals 310 as a function of a divider ratio signal 314B that is provided by the cache power management unit 309. To this end, external clock settings 318 are output for setting a clock of the SRAM 304. By this design, the appropriately-selected one of the clock signals 310 (that clocks the serviced component, etc.) may be stepped down for clocking the SRAM 304.

By this design, a first module (e.g. cache control unit 302, other circuitry, etc.) is provided to, in response to receiving a memory request, identify information in connection with the memory request. Further, a second module (e.g. cache power management unit 309, other circuitry, etc.) is provided to set at least one of a clock speed or a voltage of at least a portion of the cache memory, based on the information. As mentioned earlier, such voltage/clock control may be administered with greater precision as a result of the information that is identified in connection with active memory requests. This may, in turn, result in greater power savings that would otherwise be foregone in systems that lack such intelligent, fine-grained clock speed and/or voltage control.

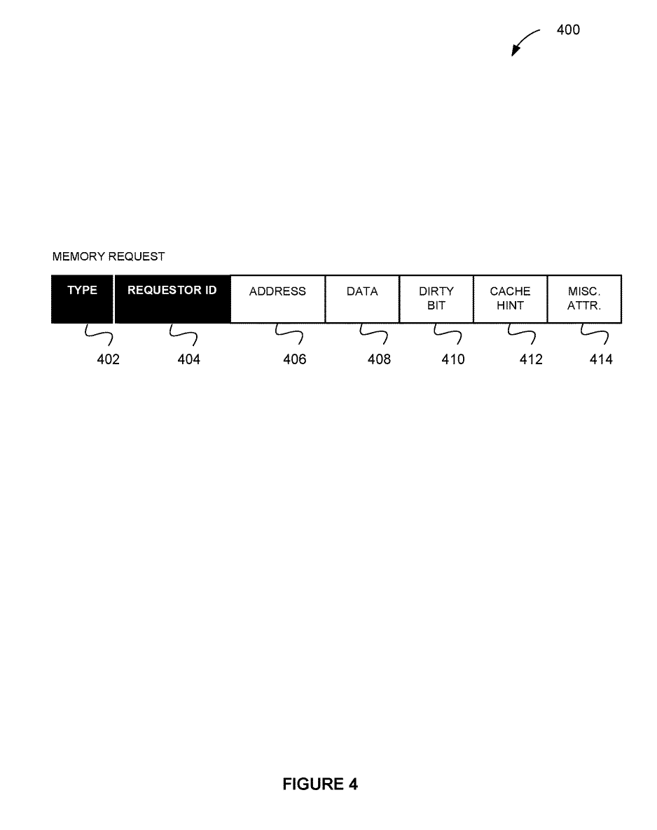

FIG. 4 illustrates a sample memory request 400 with information that may be used for setting a clock speed/voltage of cache memory, in accordance with yet another embodiment. As an option, the sample memory request 400 may be used in the context of any one or more of the embodiments set forth in any previous and/or subsequent figure(s) and/or description thereof. For example, in one embodiment, the sample memory request 400 may be received by the shared cache controller 215 of FIG. 2, the shared cache controller 300 of FIG. 3, etc.

As shown, the memory request 400 includes a plurality of fields including a type field 402, a requestor identifier field 404, an address field 406, a data field 408, a dirty bit field 410, a cache hint field 412, and a miscellaneous attribute(s) field 414. In use, the type field 402 may identify the type (e.g. a read type, a write type, a coherence type, a prefetch type, or a flush type, etc.) of the memory request, while the requestor identifier field 404 may identify the component (e.g. clusters, cores, snooping agent, etc.) that caused the memory request 400. This may be accomplished using any desired identifier (e.g. unique binary number, etc.). By this design, contents of the type field 402, the requestor identifier field 404, and/or any other field, for that matter, may be used for setting a clock speed/voltage of cache memory. More information will now be set forth regarding one possible method by which the memory request 400 may be used to set a clock speed/voltage of cache memory.

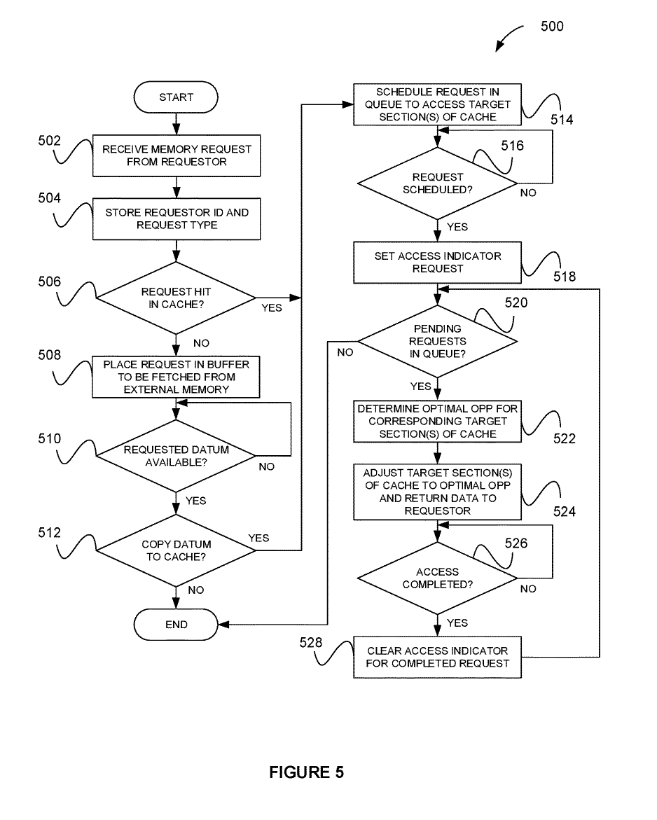

FIG. 5 illustrates a method 500 for setting a clock speed/voltage of cache memory based on memory request information, in accordance with yet another embodiment. As an option, the method 500 may be implemented in the context of any one or more of the embodiments set forth in any previous and/or subsequent figure(s) and/or description thereof. For example, in one embodiment, the method 500 may be carried out by the shared cache controller 215 of FIG. 2, the shared cache controller 300 of FIG. 3, etc. Further, the method 500 may operate in an environment that includes a non-blocking multi-banked cache, with write-back/write-allocate capabilities, as well as a prefetcher engine, multiple write buffers, and fill/evict queues. However, it is to be appreciated that the method 500 may be implemented in the context of any desired environment.

As shown, in step 502, a memory request is received. In various embodiments, the memory request may be received by any component disclosed herein (e.g. the shared cache controller 215 of FIG. 2, the shared cache controller 300 of FIG. 3, etc.) or any other component, for that matter. In step 504, contents of a type field, and a requestor identifier field of the memory request (e.g. type field 402, requestor identifier field 404 of FIG. 4, etc.) is stored.

It is then determined in decision 506 whether the memory request received in step 502 results in a hit (i.e. requested data is available for access, etc.). If not, the data is then requested from external memory (separate from cache memory) by placing a request in a buffer for fetching the data from the external memory. See step 508. The method 500 then polls until the requested data (e.g. datum, etc.) is available, per decision 510. It is then determined whether the data is copied to the cache memory per decision 512. It should be noted that, in some embodiments, data that is requested is sent directly to the requesting component (and thus not copied to the cache memory).

Thus, if it is determined in decision 506 that the memory request results in a hit, or it is determined in decision 512 that the data is copied to the cache memory; the method 500 continues by scheduling the memory request in a queue to access the target section(s) (e.g. bank(s), etc.) of the cache memory, per step 514. The method 500 then polls until the request is scheduled per decision 516, after which an access indicator is set for the memory request in step 518. In various embodiments, such access indicator may be any one or more bits that is stored with or separate from the memory request, for the purpose of indicating that the memory request (and any information contained therein/derived therefrom) is active and thus should be considered when setting the voltage/clock of the cache memory while being accessed by the relevant component(s) (or section(s) thereof) that caused the memory request.

Next, the method 500 determines in decision 520 whether there are any pending memory requests in the aforementioned queue. If not, the method 500 sits idle (and other power saving techniques may or may not be employed). On the other hand, if there are any pending memory requests in the aforementioned queue (e.g. the method 500 is active), an optimal voltage and/or clock (e.g. OPP, etc.) is determined for the corresponding target section(s) of the memory cache. See step 522.

In various embodiments, such OPP may be determined in any desired manner that utilizes the memory request (and/or contents thereof or information derived/resulting therefrom) to enhance power savings while the cache memory is active. In one embodiment, the optimal OPP may be determined by a cache power management unit (e.g. cache power management unit 309 of FIG. 3, etc.) as being a highest (i.e. fastest, as compared to others) clock of the requestors that are currently accessing the cache memory, as indicated by access indicators of pending memory requests in the queue.

In another embodiment, a minimum time quantum may be used before changing the OPP, in order to limit a frequency at which the OPP is changed. Thus, the memory requests may be buffered every cycle to change the OPP, but the change may be only made every other N cycles, where N=1, 2, 3 . . . X (any integer). To this end, the decision to scale the cache memory clock may be deferred, based on a context in which the cache memory is being accessed, where such context may be defined by the memory request information.

In another possible embodiment, such quantum may be mandated to compensate for delays in changing the OPP based on a rate of memory requests. In still other embodiments, glitch-free multiplexer designs may be used that minimize lock delays when selecting and changing the clock. Still yet, the selected cache/bank voltage of the cache memory may be different or the same as the voltage needed for the clock generator.

In any case, the target section(s) of the cache memory may be adjusted to the optimal OPP and then return the data to the requestor. See step 524. The method 500 then polls per decision 526 until the access is complete, after which the aforementioned access indicator is cleared in step 528 for the memory request that caused the access, since such memory request, at such point, has already been serviced and is no longer relevant in any subsequent calculation of the optimal OPP.

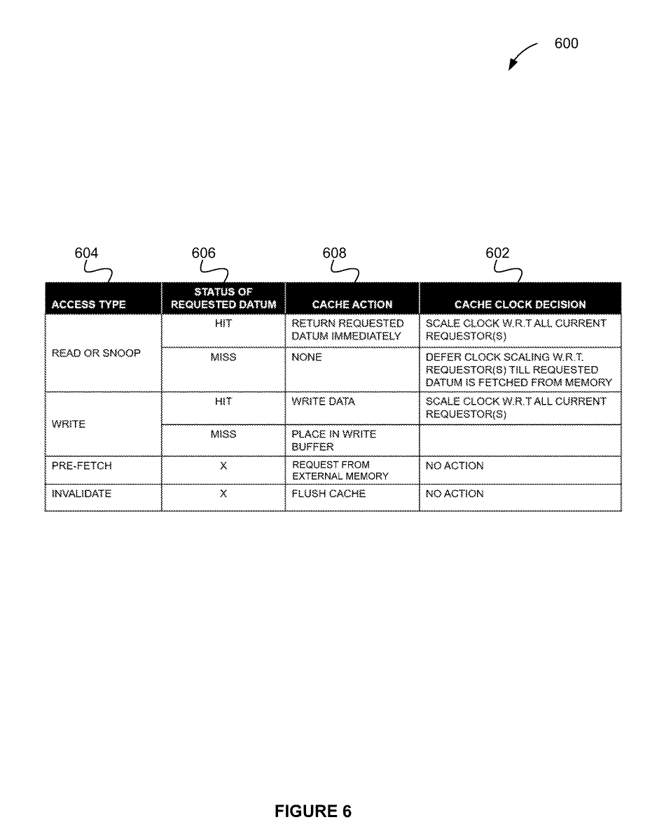

FIG. 6 illustrates additional variations 600 for setting a clock speed/voltage of cache memory based on memory request information, in accordance with yet another embodiment. As an option, the additional variations 600 may be implemented in the context of any one or more of the embodiments set forth in any previous and/or subsequent figure(s) and/or description thereof. However, it is to be appreciated that the additional variations 600 may be implemented in the context of any desired environment.

As shown, various cache clock decisions 602 may be afforded as a function of different combinations of an access type 604, data status 606, and cache action 608. For instance, in the case of a read or snoop access type where the data status indicates a hit and the cache action is a read, the clock may be scaled with respect to all current requestor(s). Further, also in the case of a read or snoop access type, but where the data status indicates a miss and the cache action is null, the clock may be scaled with respect to the requestor(s) until the requested data is fetched from memory. Still yet, in the case of a write access type where the data status indicates a hit and the cache action is a write, the clock may be scaled with respect to all current requestor(s). Even still, other examples are illustrated where no action is carried out to optimize the clock/voltage.

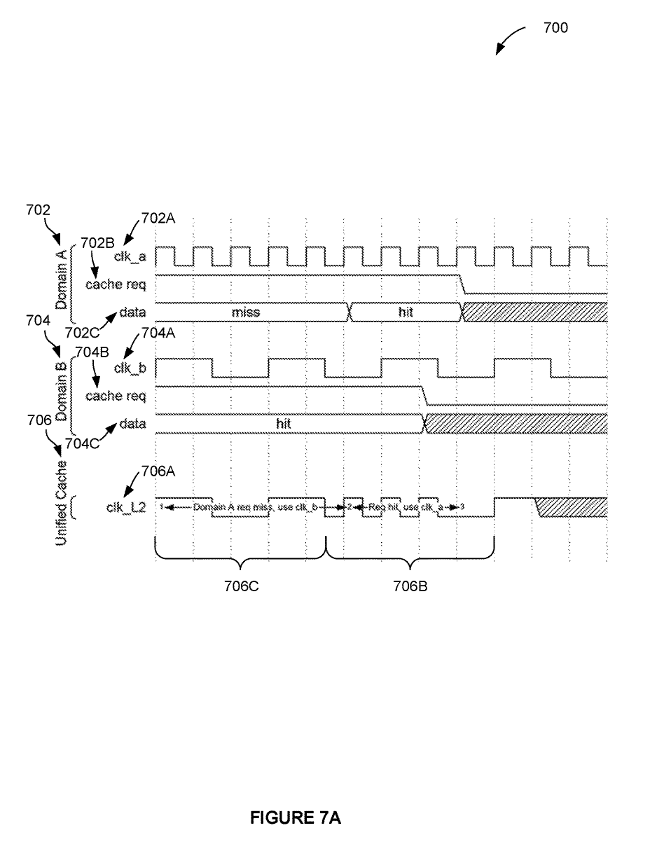

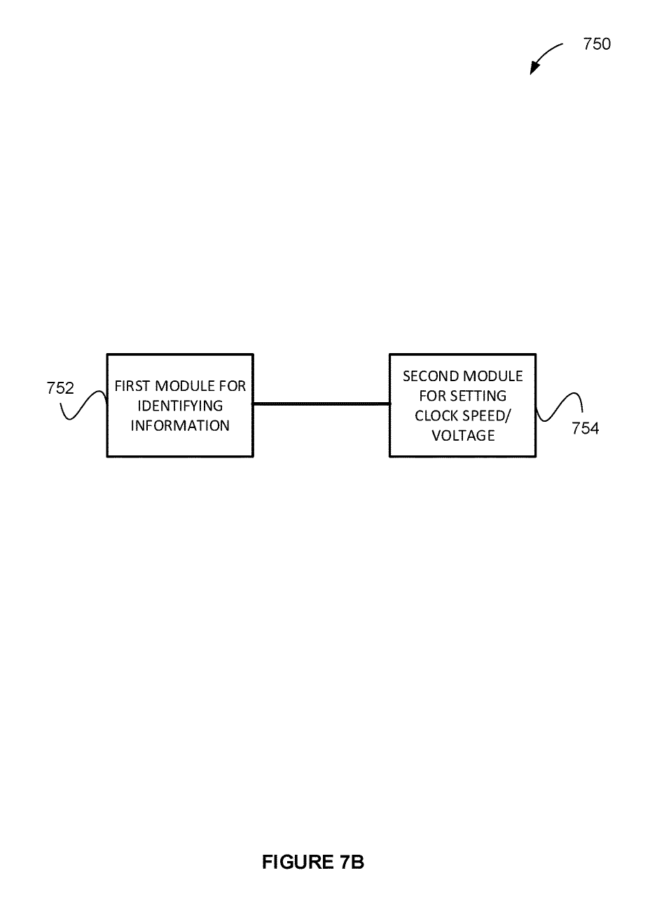

FIG. 7A illustrates an exemplary timing diagram 700 for setting a clock speed/voltage of cache memory based on memory request information, in accordance with yet another embodiment. As an option, the exemplary timing diagram 700 may reflect operation of any one or more of the embodiments set forth in any previous and/or subsequent figure(s) and/or description thereof.

As shown, a first domain 702 (e.g. including at least one requesting component, etc.) includes a first clock 702A, and a cache request 702B that that results in a data status 702C. Further, a second domain 704 (e.g. including at least one other requesting component, etc.) includes a second clock 704A, and a cache request 704B that that results in a data status 704C. Still yet, a cache memory 706 is shown to include a third clock 706A. While two domains 702, 704 are described in the context of the present embodiment, it should be noted that other embodiments are contemplated with more or less of such domains.

Based on the fact that the data status 702C of the first domain 702 indicates a miss during period 706C, the second clock 704A is utilized to drive the third clock 706A of the cache memory by setting the same to the second clock 704A of the second domain 704 during such period, as shown. However, once the data status 702C indicates a hit during period 706B, the first clock 702A is utilized to drive the third clock 706A of the cache memory 706 by setting the same to the first clock 702A of the first domain 702 during such period. While the third clock 706A of the cache memory 706 is shown to switch between the two different clock rates, it should be noted that some delay may be incorporated between such transition.

Thus, the decision to scale the cache memory clock may be deferred to a later time, based on a context in which the cache memory is being accessed. By deferring any voltage/clock scaling, power savings may be afforded.

FIG. 7B illustrates a system 750 for setting a clock speed/voltage of cache memory based on memory request information, in accordance with another embodiment. As an option, the system 750 may be implemented in the context of any one or more of the embodiments set forth in any previous and/or subsequent figure(s) and/or description thereof. However, it is to be appreciated that the system 750 may be implemented in the context of any desired environment.

As shown, the system 750 includes first means in the form of a first module 752 (e.g. first circuitry, a module performing operation 104 of FIG. 1, a first portion of the controller 215 in FIG. 2 such as the cache control unit 302 in FIG. 3, etc.) which is configured to, in response to receiving a memory request, identify information in connection with the memory request. Also included is second means in the form of a second module 754 (e.g. second circuitry, a module performing operation 106 of FIG. 1, a second portion of the controller 215 in FIG. 2 such as the cache power management unit 309 and the clock divider 316 in FIG. 3, etc.) in communication with the first module 752, where the second module 754 is configured to set at least one of a clock speed or a voltage of at least a portion of cache memory, based on the information. In one embodiment, the system 750 may be configured to operate in accordance with the method 100 of FIG. 1A. For example, the system 750 may, in such embodiment, include a receiving module (or means) for receiving memory requests in accordance with operation 102 of FIG. 1.

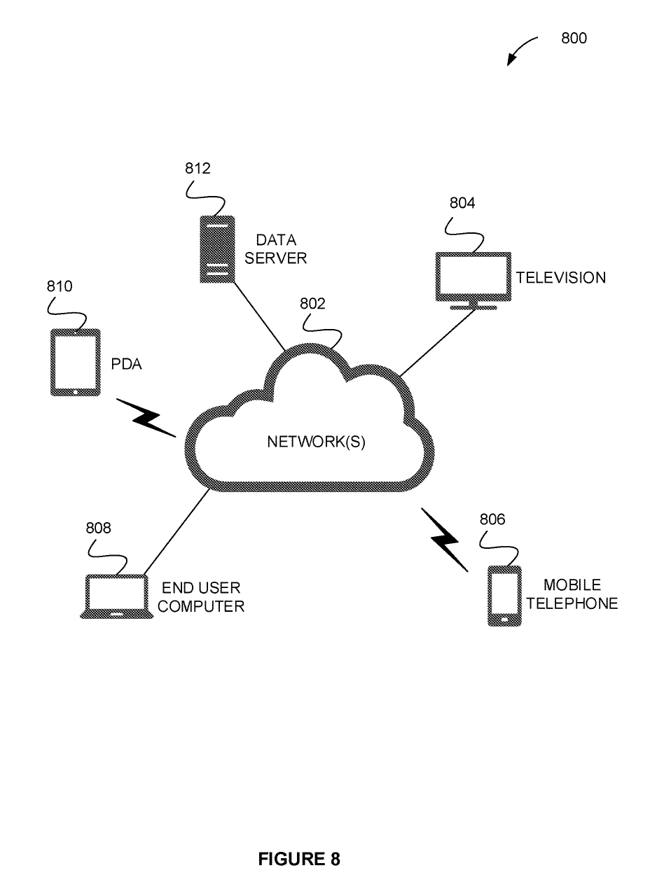

FIG. 8 illustrates a network architecture 800, in accordance with one embodiment. In one embodiment, the aforementioned cache memory voltage/clock control of any one or more of the embodiments set forth in any previous and/or subsequent figure(s) and/or description thereof, may be incorporated in any of the components shown in FIG. 8.

As shown, at least one network 802 is provided. In the context of the present network architecture 800, the network 802 may take any form including, but not limited to a telecommunications network, a local area network (LAN), a wireless network, a wide area network (WAN) such as the Internet, peer-to-peer network, cable network, etc. While only one network is shown, it should be understood that two or more similar or different networks 802 may be provided.

Coupled to the network 802 is a plurality of devices. For example, a server computer 812 and an end user computer 808 may be coupled to the network 802 for communication purposes. Such end user computer 808 may include a desktop computer, lap-top computer, and/or any other type of logic. Still yet, various other devices may be coupled to the network 802 including a personal digital assistant (PDA) device 810, a mobile phone device 806, a television 804, etc.

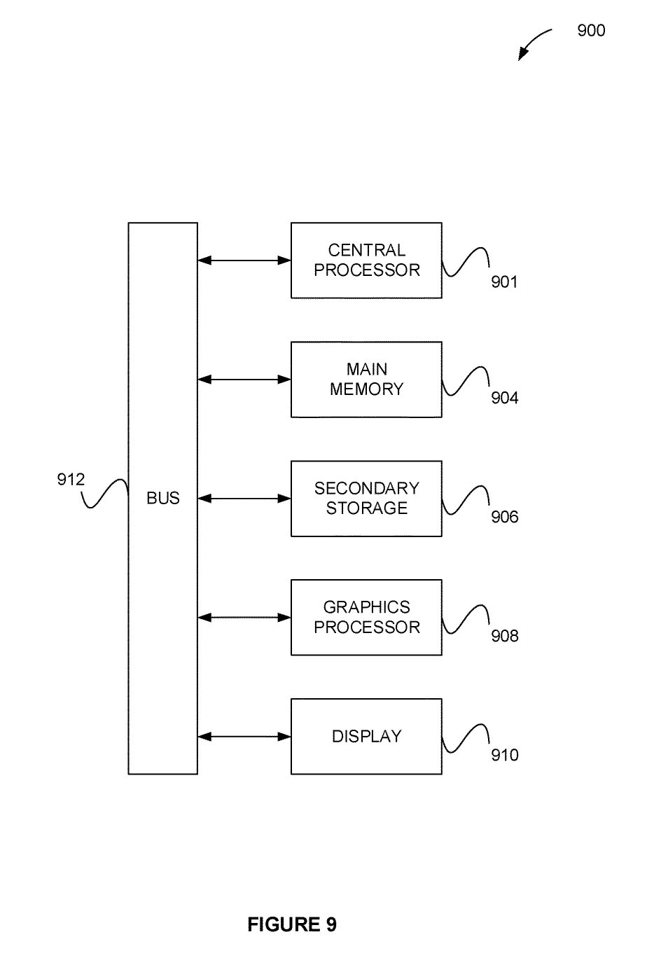

FIG. 9 illustrates an exemplary system 900, in accordance with one embodiment. As an option, the system 900 may be implemented in the context of any of the devices of the network architecture 800 of FIG. 8. However, it is to be appreciated that the system 900 may be implemented in any desired environment.

As shown, a system 900 is provided including at least one central processor 902 which is connected to a bus 912. The system 900 also includes main memory 904 [e.g., hard disk drive, solid state drive, random access memory (RAM), etc.]. The system 900 also includes a graphics processor 908 and a display 910.

The system 900 may also include a secondary storage 906. The secondary storage 906 includes, for example, a hard disk drive and/or a removable storage drive, representing a floppy disk drive, a magnetic tape drive, a compact disk drive, etc. The removable storage drive reads from and/or writes to a removable storage unit in a well-known manner.

Computer programs, or computer control logic algorithms, may be stored in the main memory 904, the secondary storage 906, and/or any other memory, for that matter. Such computer programs, when executed, enable the system 900 to perform various functions (as set forth above, for example). Memory 904, secondary storage 906 and/or any other storage are possible examples of non-transitory computer-readable media.

It is noted that the techniques described herein, in an aspect, are embodied in executable instructions stored in a computer readable medium for use by or in connection with an instruction execution machine, apparatus, or device, such as a computer-based or processor-containing machine, apparatus, or device. It will be appreciated by those skilled in the art that for some embodiments, other types of computer readable media are included which may store data that is accessible by a computer, such as magnetic cassettes, flash memory cards, digital video disks, Bernoulli cartridges, random access memory (RAM), read-only memory (ROM), and the like.

As used here, a “computer-readable medium” includes one or more of any suitable media for storing the executable instructions of a computer program such that the instruction execution machine, system, apparatus, or device may read (or fetch) the instructions from the computer readable medium and execute the instructions for carrying out the described methods. Suitable storage formats include one or more of an electronic, magnetic, optical, and electromagnetic format. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; and the like.

It should be understood that the arrangement of components illustrated in the Figures described are exemplary and that other arrangements are possible. It should also be understood that the various system components (and means) defined by the claims, described below, and illustrated in the various block diagrams represent logical components in some systems configured according to the subject matter disclosed herein.

For example, one or more of these system components (and means) may be realized, in whole or in part, by at least some of the components illustrated in the arrangements illustrated in the described Figures. In addition, while at least one of these components are implemented at least partially as an electronic hardware component, and therefore constitutes a machine, the other components may be implemented in software that when included in an execution environment constitutes a machine, hardware, or a combination of software and hardware.

More particularly, at least one component defined by the claims is implemented at least partially as an electronic hardware component, such as an instruction execution machine (e.g., a processor-based or processor-containing machine) and/or as specialized circuits or circuitry (e.g., discreet logic gates interconnected to perform a specialized function). Other components may be implemented in software, hardware, or a combination of software and hardware. Moreover, some or all of these other components may be combined, some may be omitted altogether, and additional components may be added while still achieving the functionality described herein. Thus, the subject matter described herein may be embodied in many different variations, and all such variations are contemplated to be within the scope of what is claimed.

In the description above, the subject matter is described with reference to acts and symbolic representations of operations that are performed by one or more devices, unless indicated otherwise. As such, it will be understood that such acts and operations, which are at times referred to as being computer-executed, include the manipulation by the processor of data in a structured form. This manipulation transforms the data or maintains it at locations in the memory system of the computer, which reconfigures or otherwise alters the operation of the device in a manner well understood by those skilled in the art. The data is maintained at physical locations of the memory as data structures that have particular properties defined by the format of the data. However, while the subject matter is being described in the foregoing context, it is not meant to be limiting as those of skill in the art will appreciate that various of the acts and operations described hereinafter may also be implemented in hardware.

To facilitate an understanding of the subject matter described herein, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

The embodiments described herein include the one or more modes known to the inventor for carrying out the claimed subject matter. It is to be appreciated that variations of those embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

What is claimed is:

1. A method, comprising:
receiving a memory request;
in response to receiving the memory request, identifying information in connection with the memory request, utilizing hardware that is in electrical communication with cache memory; and
based on the information, setting at least one of a clock speed or a voltage of at least a portion of the cache memory, utilizing the hardware that is in electrical communication with the cache memory.

2. The method of claim 1, wherein the information is related to at least a portion of at least one processor that caused the memory request.

3. The method of claim 1, wherein the information is related to at least one of a clock speed or a voltage of at least a portion of at least one processor that caused the memory request.

4. The method of claim 1, wherein the information is related to a type of the memory request.

5. The method of claim 4, wherein the type of the memory request includes at least one of a read type, a coherence type, a write type, a prefetch type, or a flush type.

6. The method of claim 1, wherein the information is related to a status of data that is a subject of the memory request.

7. The method of claim 6, wherein the status of the data includes at least one of a hit status, a miss status, or a hit-on-prior-miss status.

8. The method of claim 1, wherein the information is related to an action of the cache memory that is caused by the memory request.

9. The method of claim 8, wherein the action of the cache memory that is caused by the memory request includes at least one of a read action, a write action, a request to external memory, a flush action, or a null action.

10. The method of claim 1, wherein the information is identified from a field of the memory request.

11. The method of claim 10, wherein the field of the memory request includes a requestor identification field.

12. The method of claim 10, wherein the field of the memory request includes a type field.

13. The method of claim 1, wherein the at least one of the clock speed or the voltage is set to at least one of a clock speed or a voltage of at least a portion of at least one processor that exhibits a highest clock speed or voltage.

14. The method of claim 1, wherein at least one of the clock speed or the voltage is set for a subset of the cache memory.

15. The method of claim 14, wherein the subset of the cache memory includes at least one bank of the cache memory.

16. The method of claim 1, wherein at least one of the clock speed or the voltage is set for an entirety of the cache memory.

17. The method of claim 1, wherein both the clock speed and the voltage are set, based on the information.

18. The method of claim 1, wherein the hardware is integrated with the cache memory.

19. An apparatus, comprising:
circuitry configured to, in response to receiving a memory request, identify information in connection with the memory request; and
circuitry configured to set at least one of a clock speed or a voltage of at least a portion of cache memory, based on the information.

20. A system, comprising:
cache memory for storing data; and
hardware in electrical communication with the cache memory, the hardware configured to:
in response to receiving a memory request, identify information in connection with the memory request, and
set at least one of a clock speed or a voltage of at least a portion of the cache memory, based on the information.
